(19) United States
(12) Patent Application Publication
(10) Pub. No.: US 2015/0070462 A1
(43) Pub. Date: Mar. 12, 2015

(54) Method, Apparatus and Computer Program Product for Generating Panorama Images

(71) Applicant: Nokia Corporation, Espoo (FI)

(72) Inventors: Veldandi Muninder, San Jose, CA (US); Basavaraja S V, Bangalore (IN)

(21) Appl. No.: 14/385,851

(22) PCT Filed: Mar. 22, 2013
(86) PCT No.: PCT/FI2013/050322

§ 371 Date: Sep. 17, 2014

(30) Foreign Application Priority Data
Mar. 28, 2012 (IN) 1202/CHE/2012

(51) Int. Cl. H04N 5/232; G06T 3/40; G06T 7/00

(52) U.S. Cl. CPC H04N 5/23238; H04N 5/23254; G06T 7/0022; G06T 3/4038; G06T 2200/32; G06T 2207/10016; G06T 2207/20076
USPC 348/36

(57) ABSTRACT

In accordance with an example embodiment a method, apparatus and computer program product are provided. The method, apparatus and computer program product comprise facilitating receipt of a plurality of images and a plurality of image statistics associated with a scene and performing ordering of the plurality of images based at least on the plurality of image statistics. The method, apparatus and computer program product also include generating a panorama image of the scene based at least on stitching the plurality of ordered images.

### TECHNICAL FIELD

Various implementations relate generally to method, apparatus, and computer program product for generating panorama images.

### BACKGROUND

Panorama image refers to an image captured with an extended field of view in one or more directions (for example, horizontally or vertically). The extended field of view is a wide-angle representation beyond that captured by an image sensor. For example, an image that presents a field of view approaching or greater than that of the human eye can be termed as a panorama image. Various devices like mobile phones and personal digital assistants (PDA) are now being increasingly configured with panorama image/video capture tools, such as a camera, thereby facilitating easy capture of the panorama images/videos.

Such devices generate a high quality panorama image by capturing a sequence of images related to the scene, where these images may have some overlapping regions between them.

The captured images are ordered and stitched together to generate the panorama image. It is noted that the automatic image ordering and computing a transformation matrix between the captured images for generation of the panorama image is a challenging task.

### SUMMARY OF SOME EMBODIMENTS

Various aspects of examples of examples embodiments are set out in the claims.

In a first aspect, there is provided a method comprising: facilitating receipt of a plurality of images and a plurality of image statistics, wherein the plurality of images and the plurality of image statistics are associated with a scene; performing ordering of the plurality of images based at least on the plurality of image statistics; and generating a panorama image of the scene based at least on stitching the plurality of ordered images.

In a second aspect, there is provided an apparatus comprising at least one processor; and at least one memory comprising computer program code, the at least one memory and the computer program code configured to, with the at least one processor, cause the apparatus to perform at least: facilitating receipt of a plurality of images and a plurality of image statistics, wherein the plurality of images and the plurality of image statistics are associated with a scene; performing ordering of the plurality of images based at least on the plurality of image statistics; and generating a panorama image of the scene based at least on stitching the plurality of ordered images.

In a third aspect, there is provided a computer program product comprising at least one computer-readable storage medium, the computer-readable storage medium comprising a set of instructions, which, when executed by one or more processors, cause an apparatus to perform at least: facilitating receipt of a plurality of images and a plurality of image statistics, wherein the plurality of images and the plurality of image statistics are associated with a scene; performing ordering of the plurality of images based at least on the plurality of image statistics; and generating a panorama image of the scene based at least on stitching the plurality of ordered images.

In a fourth aspect, there is provided an apparatus comprising: means for facilitating receipt of a plurality of images and a plurality of image statistics, wherein the plurality of images and the plurality of image statistics are associated with a scene; means for performing ordering of the plurality of images based at least on the plurality of image statistics; and means for generating a panorama image of the scene based at least on stitching the plurality of ordered images.

In a fifth aspect, there is provided a computer program comprising program instructions which when executed by an apparatus, cause the apparatus to: facilitate receipt of a plurality of images and a plurality of image statistics, wherein the plurality of images and the plurality of image statistics are associated with a scene; perform ordering of the plurality of images based at least on the plurality of image statistics; and generate a panorama image of the scene based at least on stitching the plurality of ordered images.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for generating panorama images in accordance with an example embodiment;

FIG. 3 is a flowchart depicting an example method for generating panorama images in accordance with an example embodiment;

FIG. 4 is a flowchart depicting an example method for generating panorama images in accordance with another example embodiment; and

FIG. 5 is a flowchart depicting an example method for generating panorama images in accordance with another example embodiment.

### DETAILED DESCRIPTION

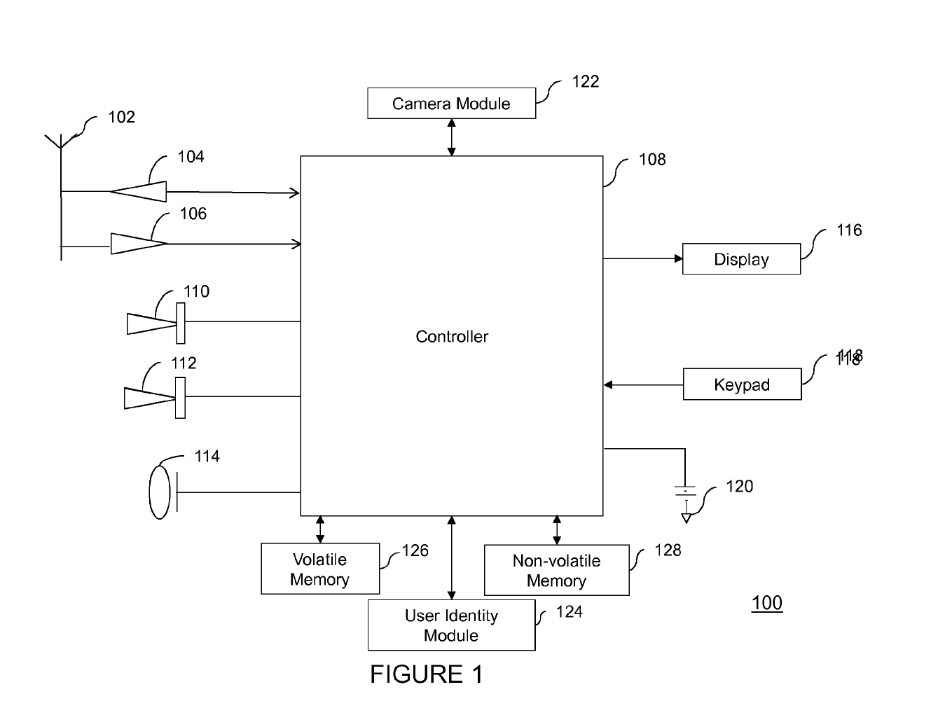

Example embodiments and their potential effects are understood by referring to FIGS. 1 through 5 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data.

The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

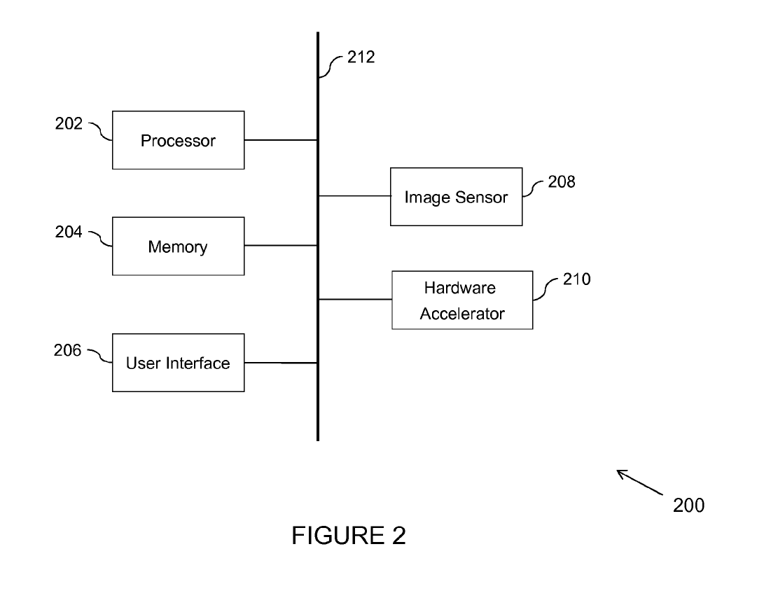

FIG. 2 illustrates an apparatus 200 for generating panorama images, in accordance with an example embodiment. The apparatus 200 may be employed for estimating image parameters, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. Alternatively, embodiments may be employed on a combination of devices including, for example, those listed above. Accordingly, various embodiments may be embodied wholly at a single device, (for example, the device 100 or in a combination of devices. Furthermore, it should be noted that the devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the electronic device may include a mobile phone, a personal digital assistant (PDA), and the like. Some examples of computing device may include a laptop, a personal computer, and the like. In an example embodiment, the electronic device may include a user interface, for example, the UI 206, having user interface circuitry and user interface software configured to facilitate a user to control at least one function of the electronic device through use of a display and further configured to respond to user inputs. In an example embodiment, the electronic device may include a display circuitry configured to display at least a portion of the user interface of the electronic device. The display and display circuitry may be configured to facilitate the user to control at least one function of the electronic device.

In an example embodiment, the electronic device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the electronic may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the electronic device may be embodied as to include a hardware accelerator 210. In an example embodiment, the hardware accelerator 210 may be embodied as ASIC or FPGA and other programmable arrays. An example of the hardware accelerator 210 may also be a graphic processing unit (GPU). The hardware accelerator 210 may be in communication with other imaging circuitries and/or software, and is specifically configured to capture image statistics. In an example embodiment, the hardware accelerator 210, alongwith other components, is configured to capture integral projections corresponding to frames from a camera stream. In some example embodiments, the functionalities of the hardware accelerator 210 may be integrated in the processor 202, and the processor 202 along with software instructions may also be configured to capture the integral projections.

These components (202-210) may communicate to each other via a centralized circuit system 212 to perform estimation/computation of image parameters. The centralized circuit system 212 may be various devices configured to, among other things, provide or enable communication between the components (202-210) of the apparatus 200. In certain embodiments, the centralized circuit system 212 may be a central printed circuit board (PCB) such as a motherboard, main board, system board, or logic board. The centralized circuit system 312 may also, or alternatively, include other printed circuit assemblies (PCAs) or communication channel media.

In an example embodiment, the processor 200 is configured to, with the content of the memory 204, and optionally with other components described herein, to cause the apparatus 200 to facilitate access images associated with a scene for generating a panorama image of the scene. In an example embodiment, the apparatus 200 is also caused to facilitate access of image statistics associated with the scene for generating the panorama image of the scene.

In an example embodiment, the processor 202 is configured to, with the content of the memory 204, and optionally with other components described herein, to cause the apparatus 200 to facilitate receipt of a plurality of images and a plurality of image statistics associated with the scene. The scene may include one or more objects, which image may be captured by image sensors such as the image sensor 208. In an example embodiment, the apparatus 200 is caused to facilitating receipt of the plurality of images and the image statistics by capturing the plurality of images and plurality of image statistics by one or more image sensors such as the image sensor 208. In an example embodiment, the plurality of images may be captured in an arbitrary direction to capture the scene. It is noted that each image may correspond to at least a portion of the scene so that and the plurality of images may be used to generate the panorama image of the scene.

In an example embodiment, the image sensor 208 may be configured to capture the plurality of images. In an example embodiment, the image sensor 208 along with the hardware accelerator 210 may be configured to capture the plurality of image statistics. In some example embodiments, the image statistics and the images may be prerecorded, stored in an apparatus 200, or may be received from sources external to the apparatus 200. In such example embodiments, the apparatus 200 is caused to receive the image statistics and the images from external storage medium such as DVD, Compact Disk (CD), flash drive, memory card, or received from external storage locations through Internet, Bluetooth®, and the like.

In an example embodiment, the image statistics may be captured on a per frame basis. Examples of the image statistics may include, but are not limited to, frames from a camera stream corresponding to the scene and integral projections of frames. In some example embodiments, the frames of the camera stream may be stored as image statistics. In an example embodiment, the camera stream may be raw stream and its display is shown on a viewfinder (for example, the UI 206) of the apparatus 200. In an example embodiment, a low resolution video may also be captured and the frames of the video may be stored as image statistics. In an example embodiment, the video may be stored in encoding formats including, but not limited to, moving picture experts group 4 (MPEG-4), and audio video interleaved (AVI). In another example embodiment, the video may be a low resolution raw video, for example, a YUV video. In some example embodiments, integral projections may be stored for frames from the camera stream, and in such example embodiments, the integral projections for the frames are stored as image statistics. The integral projection of a frame corresponds to pixel parameters in a one-dimensional pattern. For example, the sum of pixels of the frame may be computed in a direction such as horizontal, vertical and/or any angular direction to capture the integral projection. In an example embodiment, the integral projections for the frames may be stored in a memory location such as the memory 204 of the apparatus 200. In another example embodiment, a low resolution video and/or dump frames from the camera stream corresponding to the scene may be stored in the memory location such as the memory 204, so that the frames may be accessed for generation of the panorama image.

In an example embodiment, the apparatus 200 is caused to facilitating access to at least a timestamp information of the plurality of images statistics, and at least a timestamp information of the plurality of images. In an example embodiment, the apparatus 200 is caused to store timestamp information of the image statistics in the memory location such as the memory 204. In an example embodiment, timestamp information of an image statistic is a timestamp of capture of the image statistic with respect to a reference timestamp. In an example embodiment, the reference timestamp may be a timestamp of capture of the first image statistic of the plurality of image statistics. For instance, if the frames of the camera stream/video are stored as the images statistics, starting time of capture of the camera stream/video may be stored as the reference timestamp. If the integral projections are stored as image statistics, a starting time of capture of first frame may be stored. In an example embodiment, the apparatus 200 is caused to store timestamp information of each image of the plurality of images. In an example embodiment, timestamp information of an image comprises a timestamp of capture of the image with respect to the reference timestamp. It is noted that as the timestamp information of both the images and image statistics are stored, the apparatus 200 may be caused to determine an image statistic corresponding to an image based on their timestamp information.

For instance, in an example, it may be assumed that the image statistics are stored corresponding to each frame of a stream of 30 frames per second. In this example, if one image statistic (for example, integral projection) is stored per frame, then within a time period of one minute, 1800 (for example, 30*60) image statistics are stored. In this example, it may be assumed that 10 images are captured from the start of capturing the image statistics. In an example embodiment, start time of capturing of the image statistics may be recorded as the reference timestamp. For example, the reference timestamp may be time of the capture of an integral projection of the first frame, if the image statistics include integral projections. In another example, the reference time may be the time of capture of the first frame of the camera stream/video, if the image statistics include frames from a camera stream/video corresponding to the scene. For instance, in an example representation, a reference timestamp for the first image statistic may be stored as 00:00:0000 in a ‘minutes:seconds:milli-seconds’ format.

In an example embodiment, the apparatus 200 is caused to facilitate access to a timestamp information of an image statistic by storing timestamp of the image statistic with respect to the reference timestamp. For example, a timestamp information for an image statistic captured at 100 milli-seconds (ms) from the may be ‘00:00:00:0100’ with respect to the reference timestamp (start of capturing of the image stats). In an example embodiment, the apparatus 200 is caused to facilitate access to a timestamp information of an image by storing timestamp of the image with respect to the reference timestamp. For example, for an image captured at 10^{th} second from the start of the capturing of the image statistic (for example, the reference timestamp), a timestamp information may be ‘00:00:10:0000’.

In an example embodiment, the apparatus 200 is caused to order the plurality of images based on the image statistics, and caused to generate a panorama image of the scene based at least on stitching of the plurality of ordered images. In an example embodiment, the apparatus 200 is caused to perform ordering of the images by calculating a plurality of motion parameters between pairs of images of the plurality of images, and determining the order of the plurality of images based on the plurality of motion parameters.

In an example embodiment, the apparatus 200 is caused to calculate the plurality of motion parameters between pairs of images based on a plurality of motion parameters between corresponding pairs of image statistics. For example, in an example embodiment, the apparatus 200 is caused to calculate a motion parameter between a pair of images by determining a pair of image statistics corresponding to the pair of images based on the timestamp information of the plurality of image statistics and the timestamp information of the plurality of images.

For instance, in an example embodiment, the apparatus 200 is caused to determine image statistics that correspond to the plurality of images based on the timestamp information of the plurality of images and the plurality of time statistics. For instance, for two images ‘I1’ and ‘I2’, corresponding image statistics ‘K1’ and ‘K2’ may be determined. In an example of stream of 30 frames per second, ‘Kref’ denotes an image statistic corresponding to the reference timestamp (for example, the first timestamp), and ‘tref’ denotes the reference timestamp, an index of an image statistic corresponding to an image ‘Ii’ having timestamp can be determined by the expression (1):

kᵢ=kref+(tᵢ−tref)/30 (1)

In an example embodiment, indexes of image statistics (‘K1’ and ‘K2’) in the plurality of indexes of image statistics corresponding to the images (‘I1’ and ‘I2’) may be determined using the expression (1).

In an example embodiment, the apparatus 200 is caused to calculate the motion parameter between pair of image statistics ‘K1’ and ‘K2’ by calculating one or more successive motion parameters between ‘K1’ and ‘K2’ and performing a summation of the successive motion parameters. For instance, in an example embodiment, the apparatus 200 is caused to calculate a motion parameter between the pair of image statistics ‘K1’ and ‘K2’ based on the following expression (2):

$${t}_{x} ( k 1 , k 2 ) = {\sum }_{i = k 1}^{k 2 - 1} {dx}_{i} ; \\ and \\ {t}_{y} ( k 1 , k 2 ) = {\sum }_{i = k 1}^{k 2 - 1} {dy}_{i} \qquad ( 2 )$$

where tₓ(k1,k2) is a horizontal component of the motion parameter between the image statistics ‘K1’ and ‘K2’, and t_{y}(k1,k2) is a vertical component of the motion parameter between the image statistics ‘K1’ and ‘K2’; and where dxᵢ and dyᵢ are horizontal and vertical displacements between successive image statistics pairs (for example, Kᵢ and Kᵢ₊₁) between ‘K1’ and ‘K2’, such that ‘i’ varies between ‘K1’ and ‘K2−1’ for calculating the dxᵢ and dyᵢ. It is noted that in the example of 30 frames per second and for a capture of duration of 1 minute, ‘K1’, and ‘K2’ can be as 1<k1<1800 and 1<k2<1800. In some example embodiment, where the image statistics include frames of the encoded video (for example, in MPEG-4, AVI, and the like), the motion parameter between the pair of frames may also be calculated based on motion vectors between frames of the video.

In an example embodiment, the apparatus 200 is caused to calculate a motion parameter between the pair of images (for example, ‘I1’ and ‘I2’) based on a scaling factor (for example, ‘S’) and the motion parameter between the corresponding pair of image statistics (for example, K1 and K2) as S*tₓ(k1,k2) and S*t_{y}(k1,k2) In an example embodiment, the scaling factor may be determined based on a ratio of the resolution of the images (‘I1’ or ‘I2’) and resolutions corresponding to the image statistics (‘K1’ or ‘K2’). For example, if the images I1 and I2 are of resolution 4000×3000, and the image statistics (‘K1’, ‘K2’) are captured with a resolution of 400×300, then S=10;

In an example embodiment, the apparatus 200 is caused to determine order of the plurality of images based on the plurality of motion parameters between various pairs of images. For instance, the apparatus 200 is caused to generate a plurality of ordered images from the plurality of images, where the ordered images may be arranged with decreasing overlap between successive images. In an example embodiment, an overlap between two images may be associated with the motion parameter between the two images. For instance, a low value of motion parameter between the two images may correspond to a greater extent of overlap between the two images. In an example embodiment, the apparatus 200 may be caused to calculate the plurality of motion parameters between the reference image and each of remaining images of the plurality of images. In this example embodiment, the apparatus 200 is caused to order the images based on the decreasing overlap of the images with respect to the reference image (for example, the first image).

In an example embodiment, the apparatus 200 is caused to generate the panorama image of the scene based on stitching the plurality of ordered images. In an example embodiment, if the image statistics are integral projections, the apparatus 200 is caused to generate the panorama image by downscaling the plurality of ordered images to a plurality of low resolution images, and compute a plurality of primary homography matrices (H-matrices) for the plurality of low resolution images. For instance, if the plurality of images are captured with a resolution of 12 mega pixels (MP), these images may be downscaled to low resolution images, for example, of resolution of 1.3 MP. In an example embodiment, the apparatus 200 is caused to compute a primary H-matrix for each of the plurality of low resolution images (for example, images of 1.3 MP). In an example embodiment, the apparatus 200 is caused to compute a plurality of refined H-matrices based on the primary H-matrices for the corresponding low resolution images. In an example embodiment, the apparatus 200 is caused to increase image resolution of the low resolution image in a hierarchical manner and the corresponding primary H-matrix is updated to compute the refined H-matrix for the image using the bundle adjustment method.

In an example embodiment, if the image statistics are frames from the camera stream/video, the apparatus 200 is caused to compute a plurality of primary H-matrices for frames corresponding to the plurality of ordered images. In an example embodiment, the apparatus 200 is caused to compute H-matrix for each frame corresponding to the plurality of ordered images, as a frame from the camera stream/video may be considered as an image having low resolution. In an example embodiment, the apparatus 200 is caused to compute a plurality of refined H-matrices for the plurality of images based on the plurality of primary H-matrices for the corresponding frames using a bundle adjustment method. In an example embodiment, computation of a refined H-matrix for an image includes refining a primary H-matrix by using neighboring H-matrices for one or more neighboring images that at least partially overlap with the image. It is noted that the neighboring images that at least partially overlap with the image may be determined by motion parameters between the image and the neighboring images (which is computed using the image statistics).

In an example embodiment, the apparatus 200 is caused to warp the plurality of ordered images based on the plurality of refined H-matrices. In an example embodiment, the apparatus 200 is caused to stitch the plurality of warped images to generate the panorama image of the scene. For instance, in an example embodiment, two warped images may be stitched by computing a seam between the images and blending the images across the seam.

In various example embodiments, an apparatus such as the apparatus 200 may comprise various components such as means for facilitating receipt of a plurality of images and a plurality of image statistics associated with a scene, means for performing ordering of the plurality of images based at least on the plurality of image statistics, and means for generating a panorama image of the scene based at least on stitching the plurality of ordered images. Such components may be configured by utilizing hardware, firmware and software components. Examples of such means may include, but are not limited to, the processor 202 alongwith the memory 204, the UI 206, the image sensor 208, and the hardware accelerator 210.

In an example embodiment, the means for facilitating comprises means for capturing the plurality of images, each image associated with at least a portion of the scene, means for capturing the plurality of images statistics, where the plurality of images statistics comprises at least one of frames from a camera stream/video of the scene and integral projections of the frames, means for facilitating access to a timestamp information of the plurality of images statistics, and means for facilitating access to a timestamp information of the plurality of images. Examples of such means may include, but are not limited to, the processor 202 alongwith the memory 204, the UI 206, the image sensor 208, and the hardware accelerator 210.

In an example embodiment, means for performing the ordering of the plurality of images comprises means for calculating a plurality of motion parameters between pairs of images of the plurality of images, wherein a motion parameter between a pair of images is calculated by determining a pair of image statistics corresponding to the pair of images based on the timestamp information of the plurality of image statistics and the timestamp information of the plurality of images, calculating a motion parameter between the pair of image statistics, and calculating the motion parameter between the pair of images based on a scaling factor and the motion parameter between the pair of image statistics. The means for performing the ordering of the plurality of images comprises means for determining an order of the plurality of images to generate the plurality of ordered images based on the plurality of motion parameters. Examples of such means may include, but are not limited to, the processor 202 alongwith the memory 204.

In an example embodiment, wherein means for generating the panorama image comprises means for generating a plurality of low resolution images based on downscaling of the plurality of ordered images if the plurality of image statistics comprises integral projections, means for computing a plurality of primary homography matrices for the plurality of low resolution images, wherein each primary homography matrix corresponds to a low resolution image of the plurality of low resolution images; means for computing a plurality of refined homography matrices for the plurality of ordered images based on the plurality of primary homography matrices, wherein each homography matrix corresponds to an ordered image of the plurality of ordered images; means for warping the plurality of ordered images based on the plurality of refined homography matrices; and means for generating the panorama image based on stitching the plurality of warped images. Examples of such means may include, but are not limited to, the processor 202 that may be an example of the controller 108, alongwith the memory 204.

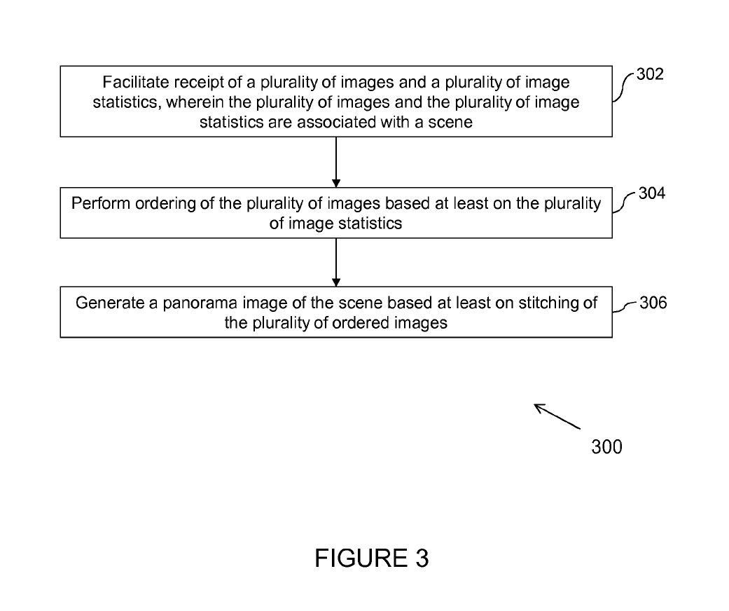

In an example embodiment, wherein means for generating the panorama image comprises means for computing a plurality of primary homography matrices for image statistics corresponding to the plurality of ordered images if the plurality of image statistics comprises the frames from a camera stream/video corresponding to the scene; means for computing a plurality of refined homography matrices for the plurality of ordered images based on the plurality of primary homography matrices, wherein each homography matrix corresponds to an ordered image of the plurality of ordered images; means for warping the plurality of ordered images based on the plurality of refined homography matrices; and means for generating the panorama image based on stitching the plurality of warped images. Examples of such means may include, but are not limited to, the processor 202 that may be an example of the controller 108, alongwith the memory 204. Various embodiments of image alignment are further described in FIGS. 3 to 5.

FIG. 3 is a flowchart depicting an example method 300 for generating panorama image, in accordance with an example embodiment. The method 300 depicted in the flow chart may be executed by, for example, the apparatus 200 of FIG. 2.

At block 302, the method 300 includes facilitating receipt of a plurality of images and a plurality of image statistics, wherein the plurality of images and the plurality of image statistics are associated with a scene. In an example embodiment, the images and the image statistics may be captured simultaneously for generating the panorama image. Each of the plurality of images may correspond to at least a portion of the scene. In an example embodiment, an image statistic may be frames of a video having lower resolution as compared to the plurality of images. In another example embodiment, the image statistics may also be integral projections of every frame from a camera stream corresponding to the scene. In an example embodiment, each image may have a corresponding image statistic, and the corresponding image statistic may be determined based at least on timestamp information of the images and the image statistics, as described in FIG. 2.

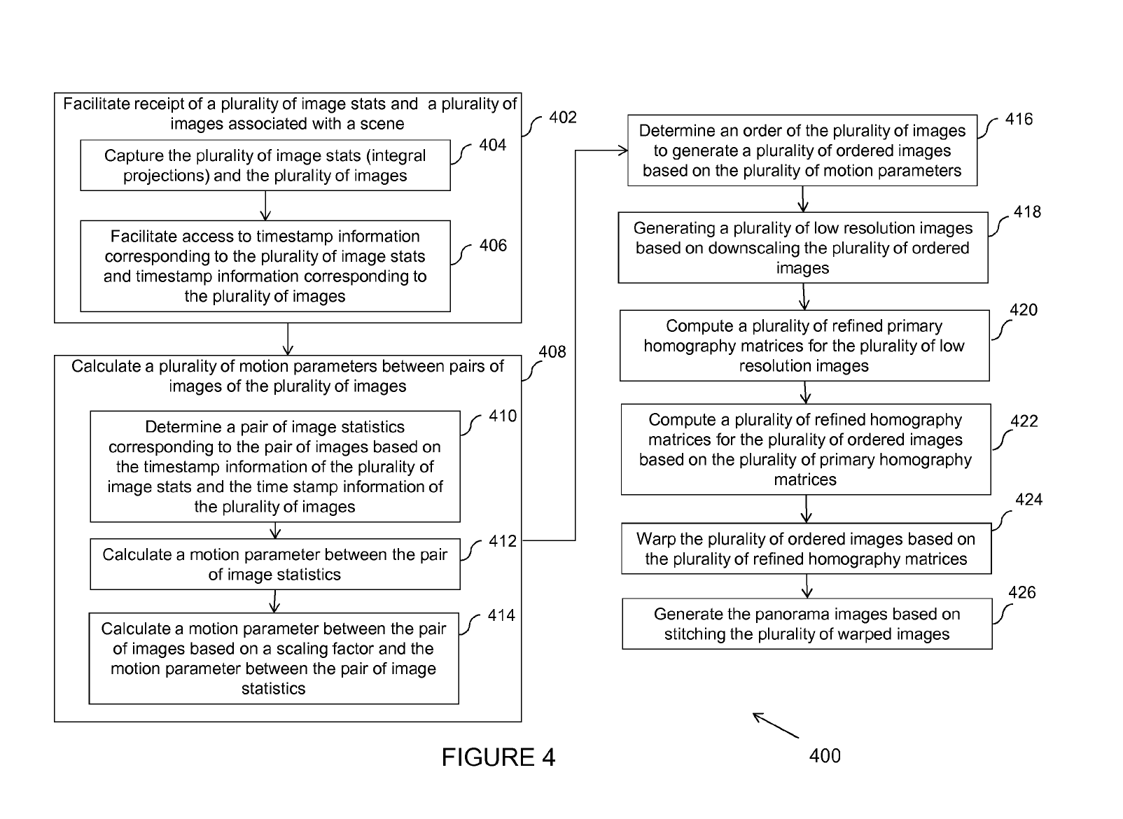

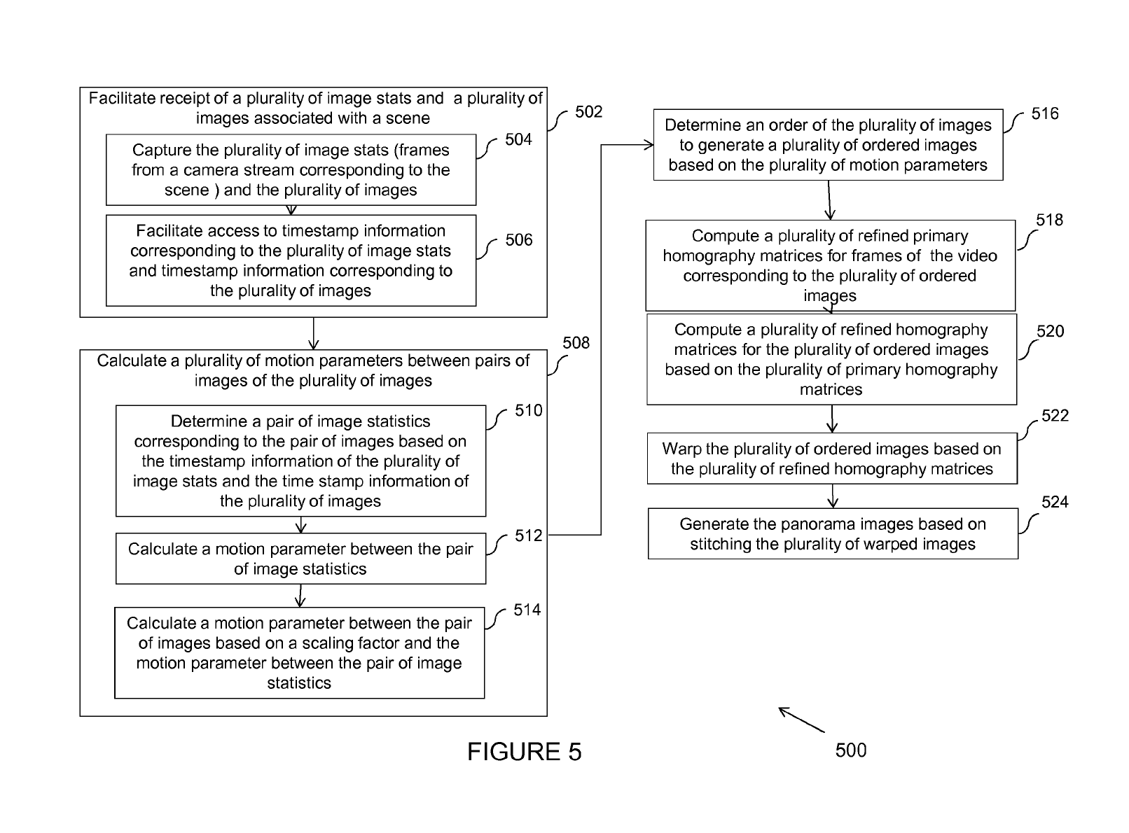

At 304, the method 300 includes performing ordering of the plurality of images based at least on the plurality of image statistics. At block 306, the method 300 includes generating a panorama image of the scene based at least on stitching the plurality of ordered images. Various example embodiments of ordering the plurality of images and generation of the panorama image are described in FIGS. 4 and 5.

FIGS. 4 and 5 are flowcharts depicting example methods 400 and 500 for generation of panorama images, in accordance with another example embodiments. The methods 400 and 500 depicted in flow charts may be executed by, for example, the apparatus 200 of FIG. 2. Operations of the flowchart, and combinations of operation in the flowcharts, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods 400 and 500 are described with help of apparatus 200. However, the operations of the methods 400 and 500 can be described and/or practiced by using any other apparatus.

Referring now to FIG. 4, at block 402, the method 400 includes facilitating receipt of a plurality of images and a plurality of image statistics associated with a scene. In an example embodiment, each of the plurality of images may be associated with at least a portion of the scene. In this example embodiment of FIG. 4, the plurality of image statistics includes integral projections of frames from a camera stream corresponding to a scene. In an example embodiment, the camera stream may be a raw image stream that is shown on a viewfinder of an apparatus such as the apparatus 200. As illustrated in FIG. 4, in an example embodiment, operation of the block 402 is performed by blocks 404 and 406.

At block 404, the plurality of images and plurality of image statistics (for example, the integral projections) are captured. In an example embodiment, capturing the integral projections refer to storing integral projection for each frame of the camera stream. At block 406, the method 400 includes facilitating access to a timestamp information of the plurality of images statistics and a timestamp information of the plurality of images. In an example embodiment, the method 400 includes facilitating access to a timestamp information of an image statistic by storing a timestamp of capture of the image statistic with respect to a reference timestamp. As described in FIG. 2, the reference timestamp may be a start time of the capture of the image statistics. In an example embodiment, the method 400 includes facilitating access to a timestamp information of an image by storing a timestamp of capture of the image with respect to the reference timestamp.

At block 408, the method 400 includes calculating a plurality of motion parameters between pairs of images of the plurality of images. In an example embodiment, the plurality of motion parameters may be calculated between a reference image of the plurality of images and each of remaining images of the plurality of images. In an example embodiment, the reference image may be first captured image of the plurality of images. As illustrated in FIG. 4, the block 408 is performed by blocks 410, 412 and 414. In this example embodiment, a motion parameter between a pair of images may be calculated based on a motion parameter between a corresponding pair of image statistics. For instance, at block 410, a pair of image statistics are determined corresponding to the pair of images based on the timestamp information of the plurality of image statistics and the timestamp information of the plurality of images. For example, an image statistic corresponding to an image may be determined by their timestamps with respect to the reference timestamp. In an example embodiment, an image and its corresponding image statistic (for example, an integral projection of a frame from the camera stream) may have same timestamps with respect to the start of the frame capture (reference timestamp). For instance, if a reference timestamp (when a panorama capture mode (frame capture) is started) is assumed at 0 second, for an image captured at 20 seconds after the start of the frame capture, the corresponding image statistic may be integral projection of the frame captured at the 20^{th} second of the frame capture.

At block 412, a motion parameter between the pair of image statistics (that are determined corresponding to the pair of images at block 410) is calculated. In an example embodiment, the motion parameter between the pair of image statistics may be calculated as described in FIG. 2. At block 414, the method 400 includes calculating a motion parameter between the pair of images based on a scaling factor and the motion parameter between the pair of image statistics, as described in FIG. 2. At block 416, the method 400 includes determining an order of the plurality of images to generate a plurality of ordered images based on the plurality of motion parameters as described in FIG. 2. For instance, the apparatus 200 is caused to generate a plurality of ordered images from the plurality of images, where the ordered images may be arranged with decreasing overlap between successive images.

At block 418, the method 400 includes generating a plurality of low resolution images based on downscaling the plurality of ordered images. In an example embodiment, resolution of the ordered images may be down-sampled to generate the low resolution images. At block 420, the method 400 includes computing a plurality of primary homography matrices (H-matrices) for the plurality of low resolution images. At block 422, the method 400 includes computing a plurality of refined homography matrices for the plurality of ordered images based on the plurality of primary H-matrices using a bundle adjustment method as described in FIG. 2. It is noted that a primary H-matrix for a low resolution image is computed for reducing the computational complexity, and the primary H-matrix may be used as an initial H-matrix to compute a refined H-matrix for the corresponding image (of higher resolution) using the bundle adjustment method.

At block 424, the plurality of ordered images may be warped based on the plurality of refined H-matrices, and at block 426, the method 400 includes generating the panorama images of the scene based on stitching the plurality of warped images. In an example embodiment, stitching two warped images may include computing a seam between the warped images and blending the warped images along the seam.

FIG. 5 is a flowchart depicting an example method 500 for generation of panorama images, in accordance with another example embodiment. At block 502, the method 500 includes facilitating receipt of a plurality of images and a plurality of image statistics associated with a scene. In this example embodiment of FIG. 5, the plurality of image statistics includes frames from a camera stream corresponding to the scene. In an example embodiment, the plurality of image statistics may include frames from a low resolution video corresponding to the scene. As illustrated in FIG. 5, in an example embodiment, operation of the block 502 is performed by blocks 504 and 506.

At block 504, the plurality of images and the plurality of image statistics (for example, frames from the camera stream/video) are captured. In an example embodiment, the video may be of a lower resolution as compared to the plurality of images that can be of higher resolution. In an example embodiment, capturing the image statistics includes storing the frames of the video. In an example embodiment, capturing the image statistics may also include storing frames the camera stream as dump frames. In an example embodiment, the video may be stored in encoded format such as MPEG-, AVI, and the like. At block 506, the method 500 includes facilitating access to a timestamp information of the plurality of frames from the camera stream/video and a timestamp information of the plurality of images. In an example embodiment, the method 500 includes facilitating access to a timestamp information of a frame by storing a timestamp of capture of the frame with respect to a reference timestamp. As described in FIG. 2, the reference timestamp may be a start time of the capture of the first frame of the video. In an example embodiment, the method 500 includes facilitating access to a timestamp information of an image by storing a timestamp of capture of the image with respect to the reference timestamp.

At block 508, the method 500 includes calculating a plurality of motion parameters between pairs of images of the plurality of images. In an example embodiment, the motion parameters may be calculated between a reference image of the plurality of images and each of remaining images of the plurality of images. In an example embodiment, the reference image may be first captured image of the plurality of images. As illustrated in FIG. 5, the block 508 is performed by blocks 510, 512 and 514. In this example embodiment, a motion parameter between a pair of images may be calculated based on a motion parameter between a corresponding pair of frames of the video. For instance, at block 510, a pair of frames is determined corresponding to the pair of images based on the timestamp information of the frames of the video and the timestamp information of the images. For example, a frame corresponding to an image may be determined by their timestamps with respect to the reference timestamp. In an example embodiment, an image and its corresponding frame of the video may have same timestamps with respect to the start of the video capture. For instance, if a reference timestamp (when the panorama capture mode is started, for example, the video capture is started) is assumed at 0 second, for an image captured at 20^{th} seconds after the start of the frame capture, the corresponding frame of the video may be the frame captured at the 20^{th} second of the video.

At block 512, a motion parameter between the pair of frames (that are identified corresponding to the pair of images at block 510) is calculated. In an example embodiment, the motion parameter between the pair of frames may be calculated based on motion vectors between frames of the video encoded in formats including, but not limited to, MPEG-4 and AVI. At block 514, the method 500 includes calculating a motion parameter between the pair of images based on a scaling factor and the motion parameter between the pair of frames, as described in FIG. 2. At block 516, the method 500 includes determining order of the plurality of images to generate a plurality of ordered images based on the plurality of motion parameters, as described in FIG. 2. For instance, the apparatus 200 is caused to generate a plurality of ordered images from the plurality of images, where the ordered images may be arranged with decreasing overlap between successive images.

At block 518, the method 500 includes computing a plurality of primary H-matrices for the frames from the camera stream/video corresponding to the plurality of ordered images. At block 520, the method 500 includes computing a plurality of refined H-matrices for the plurality of ordered images based on the plurality of primary H-matrices and a bundle adjustment. It is noted that a primary H-matrix for a frame is computed for reducing the computational complexity, and the primary H-matrix may be used as an initial H-matrix for computing a refined H-matrix for the corresponding image (of higher resolution) using the bundle adjustment method.

At block 522, the plurality of ordered images may be warped based on the plurality of refined H-matrices, and at block 524, the method 500 includes generating the panorama image of the scene based on stitching the plurality of warped images. In an example embodiment, stitching two warped images may include computing a seam between the warped images and blending the warped images along the seam.

To facilitate discussions of the methods 400 and/or 500 of FIGS. 4 and 5, certain operations are described herein as constituting distinct steps performed in a certain order. Such implementations are exemplary and non-limiting. Certain operation may be grouped together and performed in a single operation, and certain operations can be performed in an order that differs from the order employed in the examples set forth herein. Moreover, certain operations of the methods 400 and/or 500 are performed in an automated fashion. These operations involve substantially no interaction with the user. Other operations of the methods 400 and/or 500 may be performed by in a manual fashion or semi-automatic fashion. These operations involve interaction with the user via one or more user interface presentations.

Without in any way limiting the scope, interpretation, or application of the claims appearing below, a technical effect of one or more of the example embodiments disclosed herein is to generate panorama images of a scene. Various embodiments provide a mechanism for reducing the complexity in generating panorama images. For instance, various computation involved in generating panorama images are performed at frames of low resolutions as compared to images that are blended for panorama image generation. As the low resolutions frames corresponding to the images are determined based on timestamp information, so the high quality images may be taken in an arbitrarily fashion (as internally, the timestamp of every high quality image alongwith the image statistics are stored). Accordingly, a user or automated mechanism may be able to arbitrarily capture images without having to move in a UI specified fashion. Accordingly, various embodiments also eliminated the need of gyroscopes for capturing panorama images.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-36. (canceled)

37. A method comprising:
facilitating receipt of a plurality of images and a plurality of image statistics, wherein the plurality of images and the plurality of image statistics are associated with a scene;
performing ordering of the plurality of images based at least on the plurality of image statistics; and
generating a panorama image of the scene based at least on stitching the plurality of ordered images.

38. The method as claimed in claim 37, wherein the facilitating comprises:
capturing the plurality of images associated with at least a portion of the scene;
capturing the plurality of images statistics, wherein the plurality of images statistics comprises at least one of frames from a camera stream corresponding to the scene and integral projections of the frames;
facilitating access to a timestamp information of the plurality of images statistics; and
facilitating access to a timestamp information of the plurality of images.

39. The method as claimed in claim 38, wherein facilitating access to a timestamp information of an image statistic comprises storing a timestamp of capture of the image statistic with respect to a reference timestamp.

40. The method as claimed in claim 37, wherein performing the ordering of the plurality of images comprises:
calculating a plurality of motion parameters between pairs of images of the plurality of images, wherein a motion parameter between a pair of images is calculated by:
determining a pair of image statistics corresponding to the pair of images based on the timestamp information of the plurality of image statistics and the timestamp information of the plurality of images;
calculating a motion parameter between the pair of image statistics; and
calculating the motion parameter between the pair of images based on a scaling factor and the motion parameter between the pair of image statistics; and
determining an order of the plurality of images to generate the plurality of ordered images based on the plurality of motion parameters.

41. The method as claimed in claim 40, wherein calculating the motion parameter between the pair of image statistics comprises:
calculating one or more successive motion parameters between successive image statistics pairs between the pair of image stats; and
calculating the motion parameter based on summation of the one or more successive motion parameters.

42. The method as claimed in claim 40, wherein the pairs of images comprises one or more pairs formed by a reference image and each of the remaining images of the plurality of images.

43. The method as claimed in claim 40, wherein generating the panorama image comprises:
generating a plurality of low resolution images based on downscaling of the plurality of ordered images if the plurality of image statistics comprises the integral projections;
computing a plurality of primary homography matrices for the plurality of low resolution images, wherein each primary homography matrix corresponds to a low resolution image of the plurality of low resolution images;
computing a plurality of refined homography matrices for the plurality of ordered images based on the plurality of primary homography matrices, wherein each refined homography matrix corresponds to an ordered image of the plurality of ordered images;
warping the plurality of ordered images based on the plurality of refined homography matrices; and
generating the panorama image based on stitching the plurality of warped images.

44. The method as claimed in claim 40, wherein generating the panorama image comprises:
computing a plurality of primary homography matrices for image statistics corresponding to the plurality of ordered images if the plurality of image statistics comprises the frames from the camera stream;
computing a plurality of refined homography matrices for the plurality of ordered images based on the plurality of primary homography matrices, wherein each refined homography matrix corresponds to an ordered image of the plurality of ordered images;
warping the plurality of ordered images based on the plurality of refined homography matrices; and
generating the panorama image based on stitching the plurality of warped images.

45. An apparatus comprising:
at least one processor; and
at least one memory comprising computer program code, the at least one memory and the computer program code configured to, with the at least one processor, cause the apparatus to at least perform:
facilitate receipt of a plurality of images and a plurality of image statistics, wherein the plurality of images and the plurality of image statistics are associated with a scene;
perform ordering of the plurality of images based at least on the plurality of image statistics; and
generate a panorama image of the scene based at least on stitching the plurality of ordered images.

46. The apparatus as claimed in claim 45, wherein, to facilitate, the apparatus is further caused, at least in part to:
capture the plurality of images associated with at least a portion of the scene;
capture the plurality of images statistics, where the plurality of images statistics comprises at least one of frames from a camera stream corresponding to the scene and integral projections of the frames;
facilitate access to a timestamp information of the plurality of images statistics; and
facilitate access to a timestamp information of the plurality of images.

47. The apparatus as claimed in claim 46, wherein the apparatus is further caused, at least in part, to facilitate access to a timestamp information of an image statistic by storing a timestamp of capture of the image statistic with respect to a reference timestamp.

48. The apparatus as claimed in claim 45, wherein, to order the plurality of images, the apparatus is further caused, at least in part to:
calculate a plurality of motion parameters between pairs of images of the plurality of images, wherein a motion parameter between a pair of images is calculated by:
determine a pair of image statistics corresponding to the pair of images based on the timestamp information of the plurality of image statistics and the timestamp information of the plurality of images;
calculate a motion parameter between the pair of image statistics; and
calculate the motion parameter between the pair of images based on a scaling factor and the motion parameter between the pair of image statistics; and
determine an order of the plurality of images to generate the plurality of ordered images based on the plurality of motion parameters.

49. The apparatus as claimed in claim 48, wherein, to calculate the motion parameter between the pair of image statistics, the apparatus is further caused, at least in part to:
calculate one or more successive motion parameters between successive image statistics pairs between the pair of image stats; and
calculate the motion parameter based on summation of the one or more successive motion parameters.

50. The apparatus as claimed in claim 48, wherein the pairs of images comprises one or more pairs formed by a reference image and each of the remaining images of the plurality of images.

51. The apparatus as claimed in claim 48, wherein, to generate the panorama image, the apparatus is further caused, at least in part to:
generate a plurality of low resolution images based on downscaling of the plurality of ordered images if the plurality of image statistics comprises integral projections;
compute a plurality of primary homography matrices for the plurality of low resolution images, wherein each primary homography matrix corresponds to a low resolution image of the plurality of low resolution images;
compute a plurality of refined homography matrices for the plurality of ordered images based on the plurality of primary homography matrices, wherein each refined homography matrix corresponds to an ordered image of the plurality of ordered images;
warp the plurality of ordered images based on the plurality of refined homography matrices; and
generate the panorama image based on stitching the plurality of warped images.

52. The apparatus as claimed in claim 48, wherein, to generate the panorama image, the apparatus is further caused, at least in part to:
compute a plurality of primary homography matrices for image statistics corresponding to the plurality of ordered images if the plurality of image statistics comprises the frames from the camera stream;
compute a plurality of refined homography matrices for the plurality of ordered images based on the plurality of primary homography matrices, wherein each refined homography matrix corresponds to an ordered image of the plurality of ordered images;
warp the plurality of ordered images based on the plurality of refined homography matrices; and
generate the panorama image based on stitching the plurality of warped images.

53. A computer program product comprising at least one computer-readable storage medium, the computer-readable storage medium comprising a set of instructions, which, when executed by one or more processors, cause an apparatus at least to perform:
facilitate receipt of a plurality of images and a plurality of image statistics, wherein the plurality of images and the plurality of image statistics are associated with a scene;
perform ordering of the plurality of images based at least on the plurality of image statistics; and
generate a panorama image of the scene based at least on stitching the plurality of ordered images.

54. The computer program product as claimed in claim 53, wherein, to facilitate, the apparatus is further caused, at least in part to:
capture the plurality of images associated with at least a portion of the scene;
capture the plurality of images statistics, where the plurality of images statistics comprises at least one of frames from a camera stream corresponding to the scene and integral projections of the frames;
facilitate access to a timestamp information of the plurality of images statistics; and
facilitate access to a timestamp information of the plurality of images.

55. The computer program product as claimed in claim 53, wherein, to order the plurality of images, the apparatus is further caused, at least in part to:
calculate a plurality of motion parameters between pairs of images of the plurality of images, wherein a motion parameter between a pair of images is calculated by:
determine a pair of image statistics corresponding to the pair of images based on the timestamp information of the plurality of image statistics and the timestamp information of the plurality of images;
calculate a motion parameter between the pair of image statistics; and
calculate the motion parameter between the pair of images based on a scaling factor and the motion parameter between the pair of image statistics; and
determine an order of the plurality of images to generate the plurality of ordered images based on the plurality of motion parameters.

56. The computer program product as claimed in claim 55, wherein, to generate the panorama image, the apparatus is further caused, at least in part to:
generate a plurality of low resolution images based on downscaling of the plurality of ordered images if the plurality of image statistics comprises integral projections;
compute a plurality of primary homography matrices for the plurality of low resolution images, wherein each primary homography matrix corresponds to a low resolution image of the plurality of low resolution images;
compute a plurality of refined homography matrices for the plurality of ordered images based on the plurality of primary homography matrices, wherein each refined homography matrix corresponds to an ordered image of the plurality of ordered images;
warp the plurality of ordered images based on the plurality of refined homography matrices; and
generate the panorama image based on stitching the plurality of warped images.
